(19) United States
(12) Patent Application Publication
(10) Pub. No.: US 2025/0232523 A1
(43) Pub. Date: Jul. 17, 2025

(54) METHOD FOR GENERATING A VIEW USING A CAMERA SYSTEM, AND CAMERA SYSTEM

(71) Applicant: Continental Autonomous Mobility Germany GmbH, Ingolstadt (DE)

(72) Inventors: Markus Friebe, Gefrees (DE); Gustavo Machado, Blaubeuren (DE); Christian Kaps, Ulm (DE); Charlotte Gloger, Ulm (DE)

(73) Assignee: Continental Autonomous Mobility Germany GmbH, Ingolstadt (DE)

(21) Appl. No.: 18/881,433

(22) PCT Filed: Jun. 23, 2023
(86) PCT No.: PCT/DE2023/200125

§ 371 Date: Jan. 6, 2025

(30) Foreign Application Priority Data
Jul. 4, 2022 (DE) 10 2022 206 782.7

(51) Int. Cl. G06T 15/20; B60R 1/27; G06T 15/04; G06T 17/20

(52) U.S. Cl. CPC G06T 15/205; G06T 15/04; G06T 17/20; B60R 1/27; B60R 2300/105; B60R 2300/303; B60R 2300/306; B60R 2300/607; G06T 2210/12

(57) ABSTRACT

The present disclosure relates to a method for generating a view for a camera system, in particular a surround-view camera system for a vehicle, including a control device and at least one camera, wherein the view is generated by means of the following method steps: capturing at least one object from the environment data from the at least one camera; generating a bounding box for the object; projecting the object onto a ground plane; creating a bounding shape which includes the bounding box and the projected object; creating a mesh structure or grid structure for the bounding shape; and arranging the mesh structure or grid structure within the bounding box, wherein the bounding shape is adapted, in particular by image scaling and/or image distortion, to the size of the bounding box.

### CROSS-REFERENCE TO RELATED APPLICATION

The present application is a National Stage Application under 35 U.S.C. § 371 of International Patent Application No.PCT/DE2023/200125 filed on Jun. 26, 2023, and claims priority from German Patent Application No. 10 2022 206 782.7 filed on Jul. 4, 2022, in the German Patent and Trademark Office, the disclosures of which are herein incorporated by reference in their entireties.

### TECHNICAL FIELD

The present invention relates to a method for generating a view using a camera system for a vehicle, and a camera system, in particular a surround-view camera system for capturing the environment for a vehicle, which can generate a view by means of the method according to the invention.

### BACKGROUND

Modern vehicles are increasingly being equipped with driver assistance systems which support the driver during the performance of driving maneuvers. In addition to radar sensors, lidar sensors, ultrasonic sensors and/or camera sensors, these driver assistance systems also include, in particular, surround-view camera systems which allow the vehicle surroundings to be displayed to the driver of the vehicle. As a general rule, such surround-view camera systems include a control device and multiple cameras which supply real images of the vehicle surroundings, which are merged in particular by a data processing unit of the surround-view camera system to form an image of the vehicle surroundings. The image of the vehicle surroundings is then displayed to the driver on a display unit (such as, e.g., the display of the navigation system). In this way, the driver can be supported during a vehicle maneuver, for example when reversing the vehicle or during a parking maneuver. Furthermore, the surround-view cameras are, as a general rule, fisheye cameras, i.e., a camera having a fisheye lens, which supply a fisheye image. The undistorted fisheye images are then used in order to represent various views of the surroundings to the driver such as, e.g., a front view, back view, curb view and the like. Modern surround-view camera systems can then display the resulting generated views to the driver, e.g., on a display, a cockpit or a navigation system.

Furthermore, the images can also be merged into a 360° panoramic view so that the driver can select the suitable focal point by moving within a scene of a virtual camera. In this case, there are various functions or views such as “bowl” or “top view” (“birds eye's view” or “plan view”), in which images or textures from the surround-view cameras are merged or seamlessly strung together (stitching) to form an overall view (or overall texture). As a general rule, the images or textures of the surround-view cameras have overlapping areas or overlapping regions—in particular in the bowl view, in which the textures from the cameras are projected in order to visualize a virtual 3D bowl which represents the entire area around the car. Furthermore, texture information from the camera system can be projected onto a mesh (projection surface) or a static 2D plane in order to generate, e.g., a top view. However, views generated in this way can result in the captured objects being visually distorted or disturbed. This happens due to the re-projection of the object texture onto the ground surface. However, this effect is visually disturbing for the user, so there is a particular interest in avoiding such distortions.

DE 10 2014 208 664 A1 discloses a camera surround-view system for a vehicle having at least one vehicle camera which supplies camera images which are processed by a data processing unit to generate an image of the surroundings, which is displayed on a display unit, wherein the data processing unit re-projects textures which are captured by the vehicle cameras on an adaptive re-projection surface which is similar to the area surrounding the vehicle, which re-projection surface is calculated on the basis of sensor data provided by vehicle sensors, as a result of which distortions or distorted artifacts are minimized or eliminated.

Furthermore, a method is known from EP 2 973 420 B1, in which in order to render graphics in the three-dimensional virtual surroundings of a vehicle, a default three-dimensional projection surface is generated from camera data or images from multiple cameras, which is centered around a virtual representation of the vehicle in the virtual surroundings. The projection surface is generated by means of first polygon model data corresponding to the shape of an object in the surroundings. The three-dimensional projection surface is then deformed with reference to the first polygon model data for an object at a location in the virtual surroundings corresponding to a relative distance and a direction of the object, wherein the object has been captured by means of environmental sensor data. The images can subsequently be projected onto the deformed three-dimensional projection surface and are displayed with the aid of a display apparatus in an in-vehicle information system, wherein the displayed graphics correspond to the deformed three-dimensional projection surface with the plurality of projected images.

### SUMMARY

The problem of the present disclosure is therefore to provide a generic (surround-view) camera system which prevents the representation of distorted objects in order to represent objects or obstacles in the vehicle surroundings in a manner which is as clearly visible and as free of distortion as possible.

The aforementioned problem is addressed by the entire teaching of claim 1. Expedient embodiments of the present disclosure are claimed in the subclaims.

In the case of the method according to the present disclosure for generating a view for a camera system, in particular a surround-view camera system for a vehicle, the camera system includes a control device and at least one camera—such as multiple cameras, wherein the view is generated by means of the following method steps:
capturing at least one object from the environment data from the at least one camera;
generating a bounding box for the object;
projecting the object onto a ground plane;
-creating a bounding shape which includes the bounding box and the projected object;
creating a mesh structure or grid structure for the bounding shape; and
arranging the mesh structure or grid structure within the bounding box, wherein the bounding shape can be adapted, in particular by image scaling and/or image distortion, to the size of the bounding box. Within the meaning of the present disclosure, image scaling is understood to be a resizing of an image or of the bounding shape or of the mesh structure of the bounding shape. For example, during the scaling, the image resolution can be altered so that a new image with a higher or lower number of pixels is generated. For example, during the course of the image scaling, a “texture mapping” or a “pattern mapping” can also take place, wherein surfaces of models, in particular of three-dimensional surface models, are designed with two-dimensional images (textures) and possibly also surface properties. The textures make the images appear more detailed and more realistic. With reference to the present disclosure, the bounding box can be adapted to the size of the bounding box as a type of model with the image of the projected object. Within the meaning of the present disclosure, image distortion or “image warping” is understood to be an image-based technique, in which, e.g., the depth values associated with one image are transformed with the aid of a so-called reshaping or warping equation (“morphing” or “image morphing”) such that the image is deformed/distorted in the desired manner and/or can be viewed from a different focal point (in real time).

The present disclosure is aimed at improving a diagonally distorted appearance of objects in the surroundings of the vehicle. For example, in the bird's eye view or top view, these objects are projected onto the ground, wherein the projected shape of these objects is positioned in the image such that its projection looks straight and not diagonally distorted, so that the objects in the vehicle surroundings are represented in a clearly visible and distortion-free manner, which in many cases significantly improves the visual appearance of these objects and the spatial representation.

The view can expediently include a 2D view, in particular a top view, a 3D view, in particular a bowl, or the like.

The bounding box may be designed to be two-dimensional and axis-oriented. In particular, this can be a two-dimensional geometrical shape (e.g., a circle, polygon such as, e.g., a rectangle, square, triangle, hexagon or the like). This shape can be chosen in a practical manner as a function of the outline or contour of the respective object or the associated detection points.

According to an embodiment of the present disclosure, the mesh structure or the grid structure includes a triangular mesh or a triangular grid. However, other shapes such as, e.g., differently designed polygon meshes or polygon grids are also conceivable.

For the creation of the bounding shape discussed below in step IV, a shape may be chosen which is created by connecting corners of the bounding box with another geometrical shape, in particular a shape including a polygonal chain (e.g., triangular, square or rectangular shape), which is arranged at the opposite end of the projected points, i.e., a rectangle or square (alternatively, also another polygon or circular shape—in particular, depending on the contour of the object), for example, is arranged, which encompasses the outer points. This can then, e.g., also have a similar contour to the bounding box or a part of the bounding box. As a result, the distortion-free or less distorted representation is particularly improved.

According to an embodiment, the bounding shape can include all of the projected points for the object, wherein any outliers which can be captured, for example, via boundary values cannot be taken into account.

The mesh structure can be expediently arranged within the bounding box such that the corners and edges of the final bounding are arranged along the boundary of the original bounding box. As a result, and in a practical manner, the object is given the same scope or the same boundary as the bounding box created in step II and is, as a result, represented particularly realistically and clearly. In addition, distortions are particularly avoided.

To create the bounding box and/or the bounding shape and/or the mesh structure or grid structure, extrinsic and/or intrinsic camera parameters as well as the object data (three-dimensional data determined by means of the environment data of the cameras or other sensor technology) may be enlisted. Within the meaning of the present disclosure, intrinsic parameters are understood to be camera parameters which are coupled internally and in a fixed manner to a specific camera or digitization device. By way of contrast, extrinsic parameters are camera parameters which are external to the camera and can change with reference to the world image (location/position/alignment of the camera in the world coordinate system). With reference to a camera model, this means that extrinsic parameters define the location and the alignment of the camera with reference to the world image. By way of contrast, intrinsic parameters make possible an assignment between camera coordinates and pixel coordinates in the image or field of view (relationship between camera and image coordinate system), e.g., the focal length f and the optical center in the image plane. The camera model is, so to speak, a mapping of world coordinates onto image coordinates, wherein this is carried out by means of a 3D to 2D transformation. The intrinsic parameters do not depend on the position and orientation of the camera in the world and describe the mapping as well as the internal geometry of the camera.

Free regions resulting from arranging the mesh structure or grid structure within the bounding box can be expediently filled by propagating pixels from the surroundings into this region, and/or enlisting a historic ground structure for filling and/or enlisting texture information from various cameras. As a result, the view is particularly improved.

Furthermore, the present disclosure includes a camera system, in particular a surround-view camera system for a vehicle, which includes a control device and one or more camera(s) arranged in/on the vehicle, wherein the control device generates the view by means of the method according to the present disclosure and the cameras or the camera data or camera images.

### BRIEF DESCRIPTION OF THE DRAWINGS

The invention is explained in greater detail below with reference to expedient exemplary embodiments, wherein:

FIG. 1 shows a simplified schematic representation of an embodiment of a vehicle having a (surround-view) camera system according to the present disclosure;

FIG. 2 shows a simplified schematic representation of a course of a method according to the present disclosure; and

FIG. 3 schematically represents a simplified representation of the method according to the present disclosure by means of various steps (A-F), in which a vehicle captures an object by means of detection points, and a view of this object is generated by means of the method according to the present disclosure.

### DETAILED DESCRIPTION

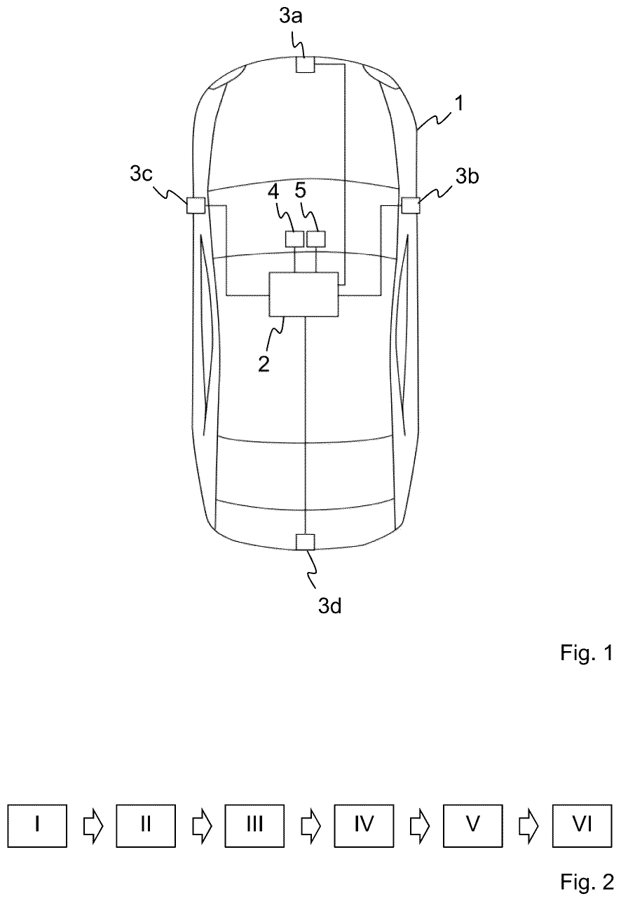

Reference numeral 1 in FIG. 1 designates a vehicle having a control device 2 (ECU, Electronic Control Unit or ADCU, Assisted and Automated Driving Control Unit), which can have recourse to various actuators (e.g., steering, engine, brake) of the vehicle 1 in order to be able to carry out control processes of the vehicle 1. Furthermore, the vehicle 1 has multiple surround-view cameras or cameras 3a-3d, a camera sensor 4 (or front camera) and a lidar sensor 5, which are controlled via the control device 2, for capturing the environment. However, the present disclosure also expressly includes embodiments in which no common control device 2 is provided, but rather individual control devices or control units for controlling sensors are provided (e.g., a separate control unit or a separate controller for controlling the cameras 3a-3d, for corresponding data processing and for performing the method according to the present disclosure). Moreover, further sensors such as, e.g., radar or ultrasonic sensors can also be provided. The sensor data can then be utilized for recognizing the environment and objects. As a consequence, various assistance functions such as, e.g., parking assistants, Electronic Brake Assist (EBA), Adaptive Cruise Control (ACC), a Lane Departure Warning System or a Lane Keep Assist (LKA) or the like can be realized. In a practical manner, the assistance functions can likewise be carried out via the control device 2 or a separate control device.

The cameras 3a-3d are part of a surround-view camera system which may be controlled by the control device 2 (alternatively, e.g., a separate control can be provided), which provides a complete 360-degree view around the entire vehicle 1 by combining the fields of view of the individual surround-view cameras, e.g., 120 degrees, to form an overall view or overall image. By simply monitoring the blind spot, this camera system has numerous advantages in many everyday situations. Various viewing angles of the vehicle 1 can be represented to the driver by the surround-view camera system, e.g., via a display unit (not shown in FIG. 1). As a general rule, four surround-view cameras 3a-3d are used, which are arranged, e.g., in the front and back region as well as on the side mirrors. In addition, three, six, eight, ten or more surround- view cameras can, however, also be provided. These camera views or viewing angles are particularly helpful when checking the blind spot, changing lanes or parking.

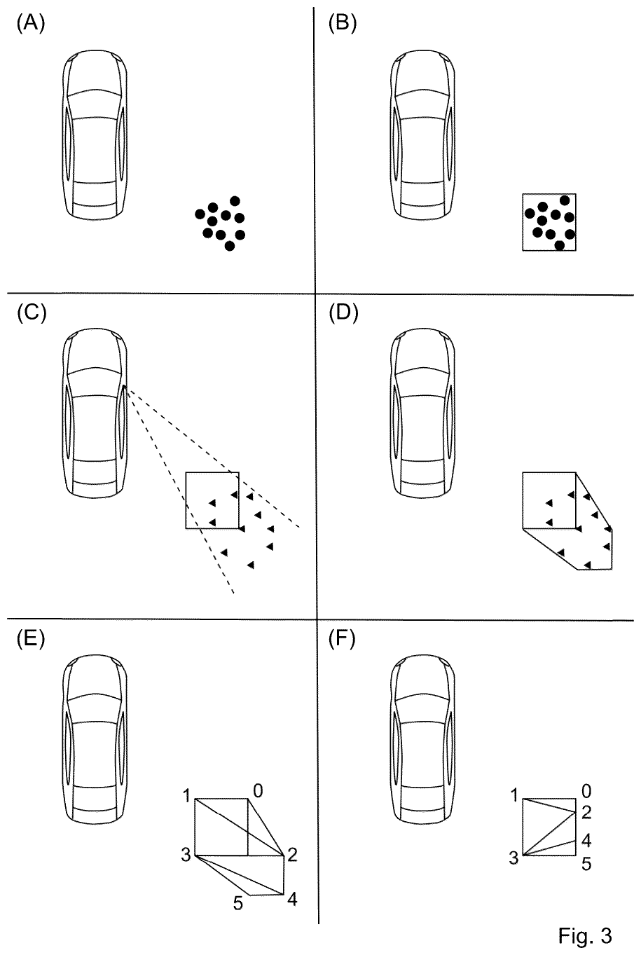

The method according to the present disclosure is schematically represented in FIG. 2 and has the method steps described below.

Step I: Capturing an object (or multiple objects) from three-dimensional environment data (FIG. 3A). This step substantially depends on the camera or sensor and environment data. For example, the data can be present in the form of point clouds (as represented in FIG. 3A by means of the black points or detection points), wherein so-called point clusters are recognized if these are located, e.g., above a specific threshold above the ground plane.

Step II: The generation of a bounding box, which is in particular two-dimensional and axis-oriented, for the object (FIG. 3B) from the vehicle top view. By way of example, the X-Y axis, wherein the minimum and maximum on each axis is enlisted for a specific set of object points.

Step III: The projecting of the object onto the ground plane (FIG. 3C), wherein, e.g., a camera is arranged on the left next to the points and the points are not located on the ground so that the points are distributed across the boundaries of the bounding box when the projection is carried out to the ground (represented by means of the triangular points in FIG. 3C).

Step IV: The creation or calculation of a bounding shape which includes both the bounding box and the projected object (FIG. 3D). In a practical manner, a simple shape can be chosen, in this case, which includes both the bounding box itself and the projected objects. This simple shape can be, e.g., the connection of the bounding box, another rectangle at the other end of the projected points, and the connection of its corners. However, the resulting shape may include all of the projected points within the generated surface.

Step V: The creation of a mesh structure or grid structure (triangular mesh or triangular grid) for the bounding shape (FIG. 3E), wherein a triangular mesh structure is created in order to depict the bounding shape by connecting the angles of the shape with each polygon-triangle formation.

Step VI: The arranging of the mesh structure or grid structure within the bounding box (FIG. 3F), wherein the mesh structure or the triangular mesh from step V is adapted such that the corners and edges are arranged along the boundary of the original bounding box. The resulting shape substantially has the shape of the bounding box (from step II). The bounding shape is adapted by image scaling and/or image distortion to the size of the bounding box. This “texture mapping step,” for example, which, so to speak, transforms or reshapes the mesh structure or grid structure from step V into a mesh structure or grid structure (as represented in FIG. 3F), which substantially corresponds to the bounding of the bounding box, consequently serves to adapt the object representation accordingly. As a result, the object then affects the later display far more naturally and gives the user a better sense of orientation. As a result, e.g., parking processes can be particularly facilitated.

During the transition from step V to step VI or when removing the mesh structure or grid structure created for the bounding shape (step V), the region of the original grid structure which is not located in the bounding box (see step VI) remains free or is not filled. There is, so to speak, no visual information from current camera and time data in order to represent this region. However, various methods can be advantageously applied in order to fill this ground surface or the image region such as, e.g., the propagating of pixels from the surroundings into this region, using a historic ground structure in order to fill these regions, or using texture information from various cameras.

In summary, the visualization quality is, consequently, significantly improved by the present disclosure in that objects do not appear to be distorted and appear with a static re-projection surface. A further advantage can include of the top view being extended with parking lot markers. Without stretching, obstacles or other vehicles can be pulled into the free parking space so that the parking space markings appear to lie on the obstacle. After removing the stretching, the place where the parking space is displayed actually looks free.

### LIST OF REFERENCE NUMERALS

1 Vehicle
2 Control device
3a Camera
3b Camera
3c Camera
3d Camera
4 Camera sensor
5 Lidar sensor

1. A method for generating a view for a camera system, in particular a surround-view camera system for a vehicle, comprising a control device and at least one camera, wherein the method comprises:
capturing at least one object from the environment data from the at least one camera;
generating a bounding box for the object;
projecting the object onto a ground plane;
creating a bounding shape which comprises the bounding box and the projected object;
creating a mesh structure for the bounding shape;
arranging the mesh structure within the bounding box, wherein the bounding shape is adapted, in particular by at least one of image scaling or image distortion, to a size of the bounding box, wherein the view generated is based upon the arranged mesh structure.

2. The method according to claim 1, wherein the view comprises a 2D view, in particular a top view, or a 3D view, in particular a bowl.

3. The method according to claim 1, wherein the bounding box is designed to be-two-dimensional and axis-oriented.

4. The method according to claim 1, wherein the mesh structure comprises a polygon mesh or polygon grid.

5. The method according to claim 1, wherein, for the creation of the bounding shape, a shape is selected; which is created by connecting corners of the bounding box with another geometrical shape, which is arranged at the opposite end of the projected points.

6. The method according to claim 5, wherein the bounding shape comprises all of the projected points for the object.

7. The method according to claim 1, wherein the mesh structure is arranged within the bounding box such that corners and edges of the bounding box are arranged along the boundary of the original bounding box.

8. The method according to claim 1, wherein at least one of extrinsic or intrinsic camera parameters as well as object data corresponding to the object are enlisted to create at least one of the bounding box, the bounding shape, or the mesh structure.

9. The method according to claim 1, wherein free regions resulting from arranging the mesh structure or grid structure within the bounding box are filled by at least one of
propagating pixels from the surroundings into the free regions,
enlisting a historic ground structure for the filling, or
enlisting texture information from the at least one cameras.

10. A camera system, in particular a surround-view camera system for a vehicle, the camera system comprising
an electronic controller,
multiple cameras arranged in or on the vehicle, and
the electronic controller generates a view by the cameras,
wherein the view is generated by the method according to any one of the preceding claimsClaim 1.

11. The method according to claim 1, wherein the 2D view comprises a top view and the 3D view comprises a bowl view.

12. The method according to claim 4, wherein the mesh structure comprises a polygon mesh or a polygon grid.

13. The method according to claim 5, wherein the another geometrical shape comprises a polygonal chain.
